(19) United States
(12) Patent Application Publication
(10) Pub. No.: US 2026/0134103 A1
(43) Pub. Date: May 14, 2026

(54) STORAGE PACKAGE

(71) Applicant: SAMSUNG ELECTRONICS CO., LTD., Suwon-si (KR)

(72) Inventors: Myeongjong JU, Suwon-si (KR); Seungjae LEE, Suwon-si (KR); Jisoo KIM, Suwon-si (KR); Younsung CHU, Suwon-si (KR)

(73) Assignee: SAMSUNG ELECTRONICS CO., LTD., Suwon-si (KR)

(21) Appl. No.: 19/191,625

(22) Filed: Apr. 28, 2025

(30) Foreign Application Priority Data
Nov. 14, 2024 (KR) 10-2024-0161643

(51) Int. Cl. G06F 21/57; G06F 21/31; G06F 21/60

(52) U.S. Cl. CPC G06F 21/572; G06F 21/31; G06F 21/602

(57) ABSTRACT

A storage device includes a non-volatile memory, and a memory controller controlling the non-volatile memory. The memory controller is configured to download firmware into the non-volatile memory, the firmware including a first signature that is generated based on a first secret key, verify the first signature of the firmware using a first public key that is paired with the first secret key, decrypt a second secret key using an externally received password, write a second signature in the firmware, based on the second secret key, verify the second signature of the firmware using a second public key that is paired with the second secret key; and store the first public key and the second public key.

### CROSS-REFERENCE TO RELATED APPLICATION(S)

This application claims benefit of priority to Korean Patent Application No. 10-2024-0161643 filed on Nov. 14, 2024 in the Korean Intellectual Property Office, the disclosure of which is incorporated herein by reference in its entirety.

### BACKGROUND

One or more embodiments of the present disclosure relate to a storage device that provides security protection.

Semiconductor memory devices may be categorized into volatile memory devices, which lose stored data when power is removed, and non-volatile memory devices, which retain stored data even when power is cut off. Non-volatile memory devices are used in various fields due to advantages such as rapid operating speed, low power consumption, low noise, high capacity, and the like. Recently, non-volatile memory devices have been used for storage devices used in various electronic devices, and the storage devices may provide an update function using firmware downloaded by a host of an electronic device. However, if externally downloaded firmware is tampered with or contains malicious code, the security of the storage device may be compromised. Accordingly, there is a need for a method for solving security issues that may occur in the process of downloading and updating firmware.

### SUMMARY

An aspect of the present disclosure is to provide a storage device autonomously writing a signature in downloaded firmware and authenticating the firmware, and verifying the written signature prior to firmware execution, thereby preventing personal information or important data from being leaked in a process of updating the firmware, the storage device having enhanced security performance.

According to an aspect of the present disclosure, a storage device includes a non-volatile memory, and a memory controller configured to download firmware into the non-volatile memory, the firmware including a first signature that is generated based on a first secret key, verify the first signature of the firmware using a first public key that is paired with the first secret key, decrypt a second secret key using an externally received password, write a second signature in the firmware, based on the second secret key, verify the second signature of the firmware using a second public key that is paired with the second secret key, and store the first public key and the second public key.

According to another aspect of the present disclosure, a storage device includes a non-volatile memory, and a memory controller configured to generate a second secret key and a second public key during initial booting of the storage device, encrypt the second secret key using at least one encryption algorithm, based on an externally received password, decrypt the second secret key encrypted using the at least one encryption algorithm, write a second signature to firmware externally downloaded into the non-volatile memory, based on the second secret key, perform a verification process on the second signature of the firmware using the second public key, and execute the firmware based on a success of the verification process on the second signature.

According to another aspect of the present disclosure, a storage device includes a non-volatile memory, and a memory controller configured to generate a second secret key and a second public key during initial booting of the storage device, generate a key protection key based on a first encryption algorithm and a password received from an external source, encrypt the second secret key based on the key protection key and a second encryption algorithm, store the encrypted second secret key in the non-volatile memory, decrypt the encrypted second secret key based on the password, the first encryption algorithm, and the second encryption algorithm, write a second signature to firmware externally downloaded into the non-volatile memory, based on the second secret key, and verify the second signature of the firmware using the second public key, wherein the first encryption algorithm is configured to regenerate the key protection key based on a change in the password, and the second encryption algorithm is configured to regenerate the second secret key to be different from a previous version of the second secret key, based on the regenerated key protection key.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a schematic block diagram illustrating a storage system according to an example embodiment of the present disclosure;

FIG. 2 is a diagram illustrating an interface of a memory controller according to an example embodiment of the present disclosure;

FIG. 3 is a schematic flowchart illustrating a flow of a storage system according to an example embodiment of the present disclosure;

FIGS. 4 to 6 are diagrams illustrating an operation of a storage device according to an example embodiment of the present disclosure;

FIGS. 7 and 8 are diagrams illustrating an operation of a storage device according to an example embodiment of the present disclosure;

FIG. 9 is a diagram illustrating an operation of a storage device according to an example embodiment of the present disclosure;

FIGS. 10 and 11 are diagrams illustrating an operation of a storage device according to an example embodiment of the present disclosure; and

FIG. 12 is a diagram illustrating an operation of a storage device according to an example embodiment of the present disclosure.

### DETAILED DESCRIPTION

Hereinafter, preferred example embodiments of the present disclosure will be described with reference to the accompanying drawings.

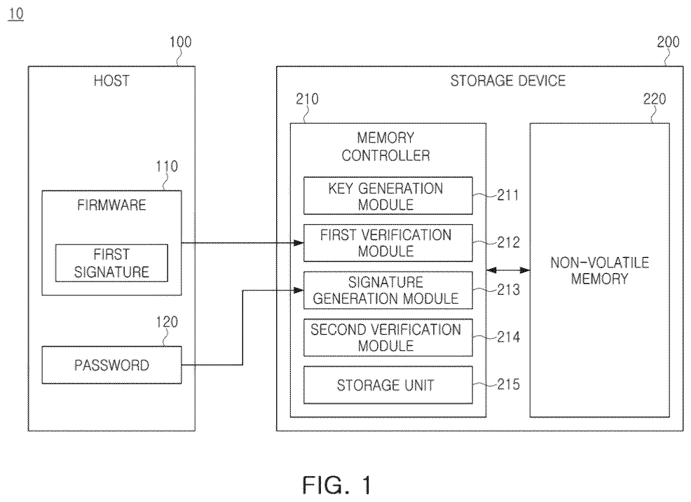

FIG. 1 is a schematic block diagram illustrating a storage system according to an example embodiment of the present disclosure.

Referring to FIG. 1, a storage system 10 may include a host 100 and a storage device 200, and the storage device 200 may include a memory controller 210 and a non-volatile memory 220.

The storage system 10 may be implemented as, for example, a personal computer (PC), a data server, network-combined storage, an Internet of Things (IoT) device, or a portable electronic device. The portable electronic device may be a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an eBook, a wearable device, or the like.

In some example embodiments, the storage device 200 may be an internal memory embedded in an electronic device. For example, the storage device 200 may be a solid-state device (SSD), an embedded universal flash storage (UFS) memory device, or an embedded multi-media card (eMMC). In some example embodiments, the storage device 200 may be an external memory detachable from the electronic device. For example, the storage device 200 may be a portable SSD, a UFS memory card, a compact flash (CF) card, a secure digital (SD) card, a micro secure digital (Micro-SD) card, a mini-SD (mini-SD) card, an extreme digital (xD) card, or a memory stick.

The host 100 may communicate with the storage device 200 through various interfaces, transmit a command and/or data to be stored in the non-volatile memory 220 to the storage device 200, and receive a response from the storage device 200 and/or data read from the non-volatile memory 220. The host 100 may be implemented as an application processor (AP), a central processing unit (CPU), a system-on-a-chip (SoC), or the like. In addition, for example, the host 100 may be implemented as an integrated circuit, a motherboard, or a database server, but the present embodiment is not limited thereto.

The non-volatile memory 220 may be referred to as a memory module or a memory device having characteristics in which stored data is maintained without loss even when power is cut off. In an example embodiment, the non-volatile memory 220 may include a flash memory, and for example, the non-volatile memory 220 may include a NAND flash memory. In an example embodiment, the non-volatile memory 220 may include a vertical NAND memory having a three-dimensional array structure (VNAND). However, the present embodiment is not limited thereto, and the non-volatile memory 220 may include a resistive memory such as a resistive RAM (ReRAM), a phase change RAM (PRAM), or a magnetic RAM (MRAM). In addition, the non-volatile memory 220 may be implemented as a magnetic disk device as well as a semiconductor memory device. In an example embodiment, the non-volatile memory 220 may include a plurality of non-volatile memory chips, and a plurality of non-volatile memory chips may communicate with the memory controller 210 via a plurality of channels.

The memory controller 210 according to an example embodiment of the present disclosure may control the non-volatile memory 220. In an example embodiment, the memory controller 210 may include a key generation module 211, a first verification module 212, a signature generation module 213, a second verification module 214, and a storage unit 215. The key generation module 211 may generate a pair of secret keys and public keys when the storage device 200 is initially booted. The term “secret key” may be also referred to as a private key. The secret key, when descripted, may not exactly match the public key, but is decrypted or verified using the corresponding paired public key. The first verification module 212 may verify a first signature of externally downloaded firmware 110. The signature generation module 213 may write a second signature in the firmware 110 in which the first signature is successfully verified. The second verification module 214 may verify the second signature included in the firmware 110. The storage unit 215 may store data to be used in the memory controller 210. For example, data required to control the non-volatile memory 220 may be stored in the storage unit 215.

In an example embodiment of the present disclosure, the storage device 200 may download the firmware 110 from the host 100 or receive a password 120 from the host 100. The host 100 may receive (download) the firmware 110 from wired/wireless data communication or a device, and transmit the received firmware 110 to the storage device 200. For example, the firmware 110 received by the host 100 may be distributed by a manufacturer of the storage device 200.

In an example embodiment, the host 100 that transmits the firmware 110 to the storage device 200 and the host 100 that transmits the password 120 may be different from each other. In an example embodiment, the password 120 may include at least one of numbers and English characters, but the embodiment is not limited thereto, and may include special characters, Korean characters, and the like. In an example embodiment, the password 120 may be a password 120 directly input by a user of the storage device 200.

The first verification module 212, included in the memory controller 210, may verify the first signature to identify whether the firmware 110 downloaded to the storage device 200 is authenticated by the manufacturer of the storage device 200. However, even when the first signature is verified, it may not guarantee that the downloaded firmware 110 is indeed authenticated by the storage device 200. Accordingly, during the firmware update process by the storage device 200, if the firmware 110 is illegally manipulated or includes malicious code, issues may occur in which personal information or important data is externally leaked.

The storage device 200 according to an example embodiment of the present disclosure may authenticate and verify the firmware 110 downloaded to the storage device 200, in the memory controller 210 including the signature generation module 212 and the second verification module 214. The firmware 110 transmitted from the host 100 may include a first signature based on a first secret key. The first verification module 212 of the memory controller 210 may verify the first signature using a first public key that is paired with the first secret key. A public key paired with a secret key may refer to a set of two cryptographic keys in an asymmetric encryption scheme, in which the public key may be openly shared and used to encrypt data or verify digital signature, and the corresponding paired secret key (or private key) may be kept confidential and may be used to decrypt data or create digital signatures. The firmware 110 on which verification is successfully performed based on the first signature may be determined as the firmware 110 distributed by the manufacturer of the storage device 200.

When the storage device 200 is initially booted, the key generation module 211 may generate a pair of a second secret key and a second public key. When the first signature of the firmware 110 is successfully verified, the signature generation module 213 may decrypt the encrypted second secret key using the externally input password 120, and may write the second signature in the firmware 110, based on the second secret key. The second verification module 214 may verify the second signature of the firmware 110 using the second public key. In an example embodiment, the first public key and the second public key may be stored in the storage unit 215 of the memory controller 210.

The storage device 200 according to an example embodiment of the present disclosure may write the second signature in the downloaded firmware 110 and authenticate the second signature, and may verify the written signature and execute the firmware 110, thereby reducing issues such as leakage of personal information or important data in a process of updating the firmware 110. In addition, only the host 100 having the password 120 may write the signature in the firmware 110 and authenticate the second signature, such that the storage device 200 may have effectively enhanced security performance.

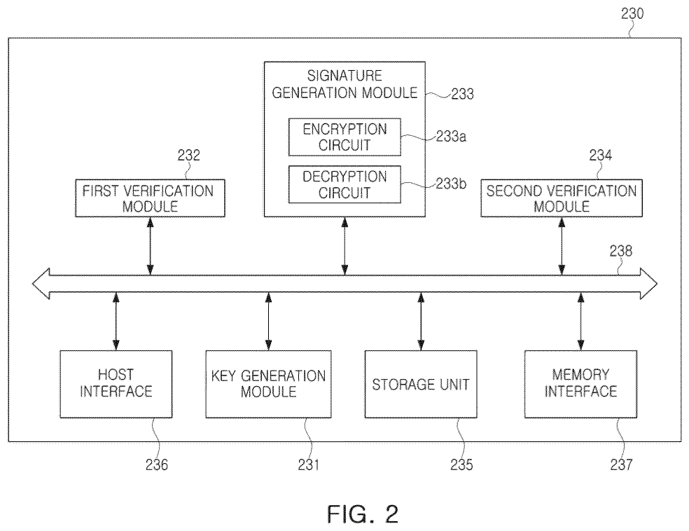

FIG. 2 is a diagram illustrating an interface of a memory controller according to an example embodiment of the present disclosure.

Referring to FIG. 2, a memory controller 230 may include a key generation module 231, a first verification module 232, a signature generation module 233, a second verification module 234, a storage unit 235, a host interface 236, and a memory interface 237. In an example embodiment, components of the memory controller 230, for example, the key generation module 231, the first verification module 232, the signature generation module 233, the second verification module 234, and the storage unit 235 may communicate with each other through a system bus 238. In an example embodiment, the memory controller 230 may further include other components, for example, a processor, a read-only memory (ROM), an error correction circuit, a buffer, and a host interface.

In an example embodiment of the present disclosure, the key generation module 231 may generate a pair of secret keys and public keys when a storage device including the memory controller 230 is initially booted. The secret key generated by the key generation module 231 may be encrypted using an externally input password in an encryption circuit 233a of the signature generation module 233. In an example embodiment, the encrypted secret key may be stored in the storage unit 235 of the memory controller 230 or in a non-volatile memory. In an example embodiment, the public key generated by the key generation module 231 may be stored in the storage unit 235 of the memory controller 230.

In an example embodiment of the present disclosure, the first verification module 232 of the memory controller 230 may verify firmware transmitted by a host. The firmware may include a first signature based on a first secret key. The storage unit 235 of the memory controller 230 may store a first public key that is paired with the first secret key. The first verification module 232 may load the first public key from the storage unit 235, and may verify a first signature included in the firmware, based on the first public key. The memory controller 230 may cancel downloading of the firmware when the first verification module 232 fails to verify the first signature. The memory controller 230 may complete downloading of the firmware when the first verification module 232 successfully verifies the first signature. In an example embodiment, the first verification module 232 may also perform an integrity check on the firmware downloaded to the storage device, such as whether data of the firmware is damaged or manipulated.

In an example embodiment of the present disclosure, the signature generation module 233 of the memory controller 230 may include an encryption circuit 233a and a decryption circuit 233b. The encryption circuit 233a of the signature generation module 233 may encrypt a second secret key using at least one encryption algorithm, based on an externally input password. The decryption circuit 233b of the signature generation module 233 may decrypt the encrypted second secret key using at least one encryption algorithm, based on the externally input password. The signature generation module 233 of the memory controller 230 may acquire the second secret key using the decryption circuit 233b, and may write the second signature in the downloaded firmware, based on the second secret key. In an example embodiment, the signature generation module 233 may store the encrypted second secret key in the storage unit 235 of the memory controller 230 or in the non-volatile memory.

The second verification module 234 of the memory controller 230 according to an example embodiment of the present disclosure may verify the second signature included in the firmware using the second public key generated by the key generation module 231 to be paired with the second secret key. In an example embodiment, the second verification module 234 may load the second public key from the storage unit 235, or may load the encrypted second secret key from the storage unit 235 of the memory controller 230 or from the non-volatile memory. In an example embodiment, the memory controller 230 may cancel loading of the firmware when the second verification module 234 fails to verify the second signature. In another example embodiment, the memory controller 230 may execute the firmware when the second verification module 234 successfully verifies the second signature.

The host interface 236 may provide an interface between the host and the memory controller 230. For example, the host interface 236 may be implemented as one of various interfaces such as a universal serial bus (USB) interface, a universal flash storage (USF) interface, a multimedia controller (MMC), an embedded MMC (eMMC) interface, a peripheral component interconnect express (PCIe) interface, an advanced technology attachment (ATA) interface, an advanced technology attachment (SATA) interface, a parallel advanced technology attachment (PATA) interface, a small computer system interface (SCSI), a serial attached SCSI (SAS), an enhanced small disk interface (ESDI), an integrated drive electronics (IDE) interface, and the like.

The memory interface 237 may provide an interface between the memory controller 230 and the non-volatile memory. Data may be transmitted and received between the memory controller 230 and the non-volatile memory through the memory interface 237. In an example embodiment, the number of memory interfaces 237 may correspond to the number of non-volatile memory chips included in the storage device or the number of channels between the memory controller 230 and the non-volatile memory.

The storage device according to an example embodiment of the present disclosure may include the memory controller 230 including the first verification module 232, the signature generation module 233, and the second verification module 234. The first verification module 232 may verify the first signature included in the downloaded firmware, thereby identifying whether the firmware is firmware authenticated by a manufacturer of the storage device and/or performing an integrity check. However, to identify whether the downloaded firmware is a firmware update according to an intention of a user using the storage device, the storage device may additionally authenticate and verify the firmware.

In an example embodiment of the present disclosure, the signature generation module 233 of the memory controller 230 may write the second signature in the firmware in which the first signature is successfully authenticated, and may authenticate that the firmware is downloaded according to the intention of the user. The second verification module 234 of the memory controller 230 may verify the second signature included in the firmware. In an example embodiment, the memory controller 230 may execute the firmware in which the second verification module 234 successfully verities the second signature, thereby reducing issues such as leakage of personal information or important data in a process of updating the firmware. Accordingly, the storage device may have effectively enhanced security performance.

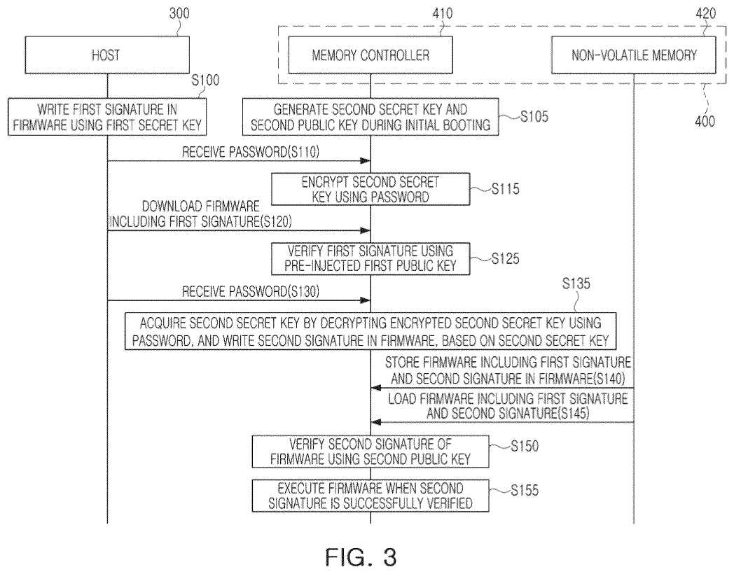

FIG. 3 is a schematic flowchart illustrating a flow of a storage system according to an example embodiment of the present disclosure.

Referring to FIG. 3, a storage system according to an example embodiment of the present disclosure may include a host 300 and a storage device 400. A storage device 400 may include a memory controller 410 and a non-volatile memory 420.

In an example embodiment of the present disclosure, the host 300 may write a first signature in firmware using a first secret key (S100). In an example embodiment, the host 300 may be a manufacturer of the storage device 400. The manufacturer of the storage device 400 may generate a first secret key and a first public key together, and may pre-inject the first public key into a storage unit of the memory controller 410. In one embodiment, the first secret key and the first public key do not necessarily need to be generated simultaneously. The first secret key and the first public key may be generated at different times but are paired to work together, with the public key used to encrypt data or verify signatures, and the secret key used to decrypt data or create signatures. The first signature may be encrypted based on the first secret key, and the encrypted first signature may be decrypted only with the first public key.

In an example embodiment of the present disclosure, the memory controller 410 may generate a second secret key and a second public key during initial booting (S105). The memory controller 410 may include a key generation module configured to generate the second secret key and the second public key when the storage device 400 is initially booted. The second secret key and the second public key, generated by the key generation module, may be stored in the storage device 400. In an example embodiment, the second secret key may be encrypted and stored in the storage unit inside the memory controller 410 or in the non-volatile memory 420 outside the memory controller 410. In an example embodiment, the second public key may be stored in the storage unit of the memory controller 410.

In an example embodiment of the present disclosure, the memory controller 410 may receive a password from the host 300 (S110). In an example embodiment, two different hosts may be use to input the password and to transmit the firmware, respectively. The password may be directly input by a user of the storage device 400. In an example embodiment, when the storage device 400 is initially booted, the storage device 400 may request the user to input the password.

The memory controller 410 according to an example embodiment of the present disclosure may encrypt the second secret key using an externally input password (S115). A signature generation module, included in the memory controller 410, may include an encryption circuit configured to encrypt the second secret key, and a decryption circuit configured to decrypt the encrypted second secret key. The encryption circuit may encrypt the second secret key using the input password and at least one encryption algorithm. The encrypted second secret key may be stored in the storage unit of the memory controller 410 or the non-volatile memory 420. The decryption circuit may decrypt the encrypted second secret key using the password and at least one encryption algorithm.

The storage device 400 according to an example embodiment of the present disclosure may download the firmware including the first signature through the host 300 (S120). The host 300 may receive the firmware from wired/wireless data communication or a device, and may transmit the received firmware to the storage device 400. For example, the firmware received by the host 300 may be distributed by the manufacturer of the storage device 400. The manufacturer of the storage device 400 may generate a first secret key and a first public key. The manufacturer of the storage device 400 may write the first signature in the firmware, based on the first secret key. The first signature may be encrypted based on the first secret key, and may be decrypted by the first public key.

In an example embodiment of the present disclosure, the storage device 400 may include the memory controller 410 including a first verification module. The first verification module of the memory controller 410 may verify the first signature of the firmware using the first public key that is pre-injected during the manufacturing process of the storage device 400 (S125). The storage device 400 that has downloaded the firmware may verify the first signature, thereby identifying whether the downloaded firmware is firmware authenticated by the manufacturer of the storage device 400. The memory controller 410 may complete downloading of the firmware when the first verification module successfully verifies the first signature.

The memory controller 410 according to an example embodiment of the present disclosure may receive a password from the host 300 (S130). The signature generation module of the memory controller 410 may encrypt the second secret key using the password, such that the encrypted second secret key may also be decrypted using the password.

In an example embodiment, the decryption circuit, included in the signature generation module, may acquire the second secret key by decrypting the encrypted second secret key using the input password, and may write the second signature in the firmware, based on the second secret key (S135). The second signature may be encrypted based on the second secret key, and the encrypted second signature may be decrypted only with the second public key. The signature generation module may write the second signature in the firmware, thereby verifying whether the firmware is updated according to an intention of a user using the storage device 400. In an example embodiment, the second secret key may be generated in the storage device 400, and the second secret key may be different from the first secret key, generated by the manufacturer of the storage device 400.

The signature generation module of the memory controller 410 according to an example embodiment of the present disclosure may store the firmware including the first signature and the second signature in the non-volatile memory 420 (S140). Before the memory controller 410 executes the firmware, a second verification module of the memory controller 410 may load the firmware including the first signature and the second signature from the non-volatile memory 420 (S145).

The second verification module of the memory controller 410 may verify the second signature of the firmware using the second public key (S150). The second public key may be generated by the key generation module of the memory controller 410 together with the second secret key when the storage device 400 is initially booted. In an example embodiment, the second public key may be stored in the storage unit of the memory controller 410. The second verification module of the memory controller 410 may load the second public key from the storage unit, and may decrypt and verify the encrypted second signature using the second public key. The second signature may be decrypted using the second public key, thereby verifying whether the firmware is updated according to the intention of the user using the storage device 400.

The memory controller 410 according to an example embodiment of the present disclosure may execute the firmware when the second verification module successfully verifies the second signature (S155). The memory controller 410 may cancel loading of the firmware when the second verification module fails to verify the second signature. The second signature included in the firmware in the second verification module may be verified, thereby verifying whether the firmware is updated according to the intention of the user using the storage device 400.

In an example embodiment of the present disclosure, in the storage device 400, the memory controller 410 may write the second signature in the firmware in which the first verification module successfully verifies the first signature, and may verify the second signature, thereby verifying whether the firmware is updated according to the intention of the user using the storage device 400. The storage device 400 may execute the firmware in which the second verification module successfully verifies the second signature, thereby reducing issues such as leakage of personal information or important data in a process of updating the firmware. Accordingly, the storage device 400 may have effectively enhanced security performance.

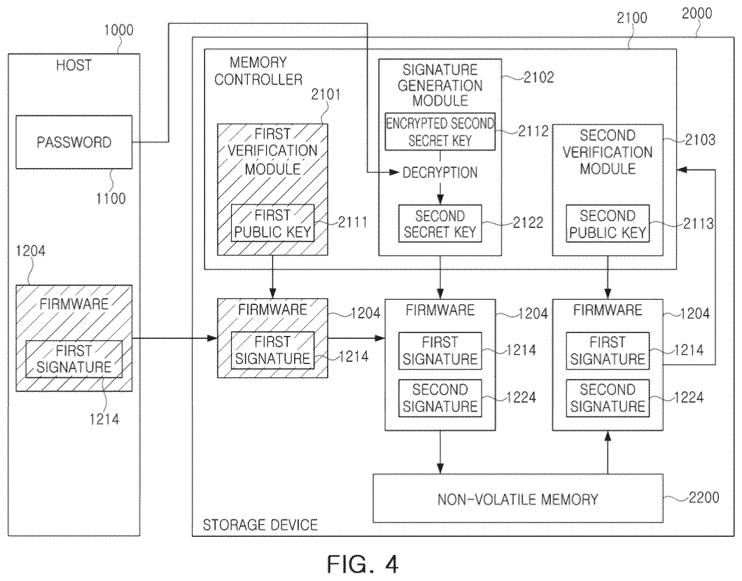

FIGS. 4 to 6 are diagrams illustrating an operation of a storage device according to an example embodiment of the present disclosure.

Referring to FIG. 4, a storage system according to an example embodiment of the present disclosure may include a host 1000 and a storage device 2000. The host 1000 may transmit a password 1100 and firmware 1204 to the storage device 2000. The storage device 2000 may include a memory controller 2100 and a non-volatile memory 2200, and the memory controller 2100 may include a first verification module 2101, a signature generation module 2102, and a second verification module 2103.

In an example embodiment of the present disclosure, the host 1000 may pre-generate a first secret key and a first public key 2111. For example, the host 1000 may be a manufacturer of the storage device 2000. The manufacturer of the storage device 2000 may generate the first secret key and the first public key 2111. The manufacturer of the storage device 2000 may write a first signature 1214 in the firmware 1204, based on the first secret key, and may pre-inject the first public key 2111 into the storage device 2000. The first signature 1214, encrypted based on the first secret key, may be decrypted using the first public key 2111. In an example embodiment, the first public key 2111 may be stored in a storage unit of the memory controller 2100.

In an example embodiment of the present disclosure, the memory controller 2100 may include a key generation module configured to generate a second secret key 2122 and a second public key 2113 when the storage device 2000 is initially booted. The second secret key 2122, generated by the key generation module, may be encrypted based on a password input from the host 1000. In an example embodiment, two different hosts may be used to transmit the firmware 1204, and to input the password, respectively. The encrypted second secret key 2112 may be stored in the storage unit of the memory controller 2100 or the non-volatile memory 2200.

Referring to FIG. 4, the host 1000 may transmit the firmware 1204 including the first signature 1214 to the storage device 2000. The first verification module 2101 of the memory controller 2100 may verify the first signature 1214 of the firmware 1204 using the first public key 2111. In an example embodiment, the first verification module 2101 may perform an integrity check as to whether the firmware 1204 is modulated. The first signature 1214 may be verified by the first verification module 2101 of the memory controller 2100, thereby identifying whether the firmware 1204 is firmware authenticated by the manufacturer of the storage device 2000.

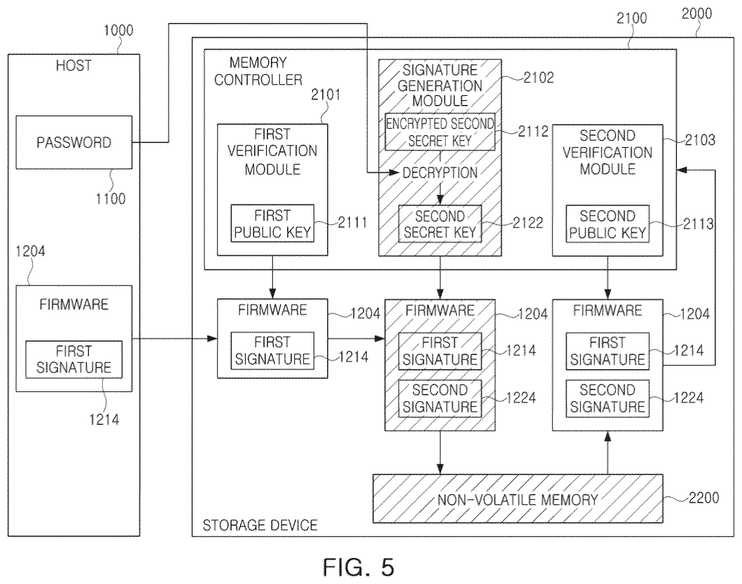

Referring to FIG. 5, in an example embodiment of the present disclosure, when the first verification module 2101 of the memory controller 2100 successfully verifies the first signature 1214, the signature generation module 2102 may write the second signature 1224 in the firmware 1204. The signature generation module 2102 may load the encrypted second secret key 2112 from the storage unit of the memory controller 2100 or the non-volatile memory 2200. The signature generation module 2102 may acquire the second secret key 2122 by decrypting the encrypted second secret key 2112 using the password 1100 input from the host 1000. The signature generation module 2102 may write the second signature 1224 in the firmware 1204, based on the second secret key 2122. The signature generation module 2102 may write the second signature 1224 in the firmware 1204, thereby authenticating that the storage device 2000 is the downloaded firmware 1204. In an example embodiment, the signature generation module 2102 may store the firmware 1204 including the first signature 1214 and the second signature 1224 in the non-volatile memory 2200.

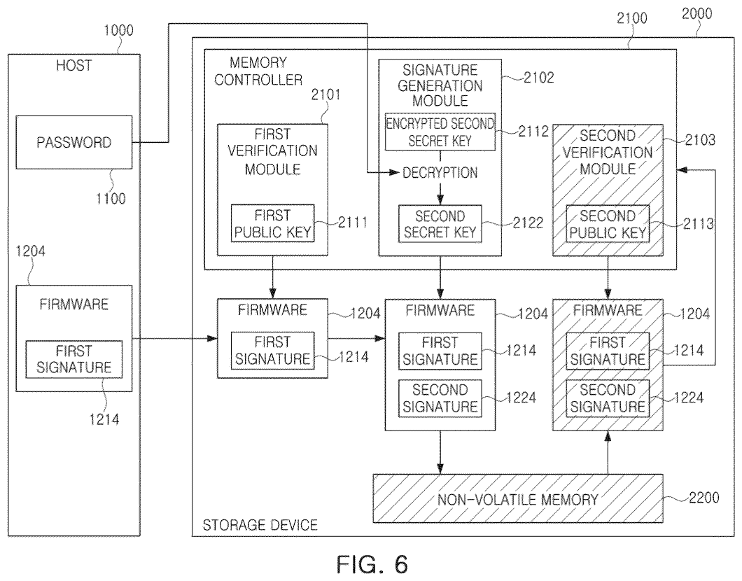

Referring to FIG. 6, the second verification module 2103 of the memory controller 2100 according to an example embodiment of the present disclosure may load the firmware 1204 including the first signature 1214 and the second signature 1224 from the non-volatile memory 2200. The second verification module 2103 may verify the second signature 1224 included in the firmware 1204, based on the second public key 2113. The second signature 1224, encrypted based on the second secret key 2122, may be decrypted using the second public key 2113. The memory controller 2100 may execute the firmware 1204 when the second verification module 2103 successfully verifies the second signature 1224. The memory controller 2100 may cancel loading of the firmware 1204 when the second verification module 2103 fails to verify the second signature 1224.

In an example embodiment of the present disclosure, the first verification module 2101 of the memory controller 2100 may identify whether the firmware 1204, transferred from the host 1000, is firmware authenticated by the manufacturer of the storage device 2000. The signature generation module 2102 of the memory controller 2100 may write, in the firmware 1204, the second signature 1224 for authenticating that the firmware 1204 is firmware downloaded by the storage device 2000. Before the firmware 1204 is executed, the second verification module 2103 of the memory controller 2100 may verify the second signature 1224 of the firmware 1204 to identify whether the firmware is updated according to an intention of a user.

In an example embodiment of the present disclosure, the signature generation module 2102 and the second verification module 2103 of the memory controller 2100 may authenticate and verify whether the firmware 1204 is firmware according to the intention of the user, such that the storage device 2000 may have effectively enhanced security performance in a process of updating the firmware.

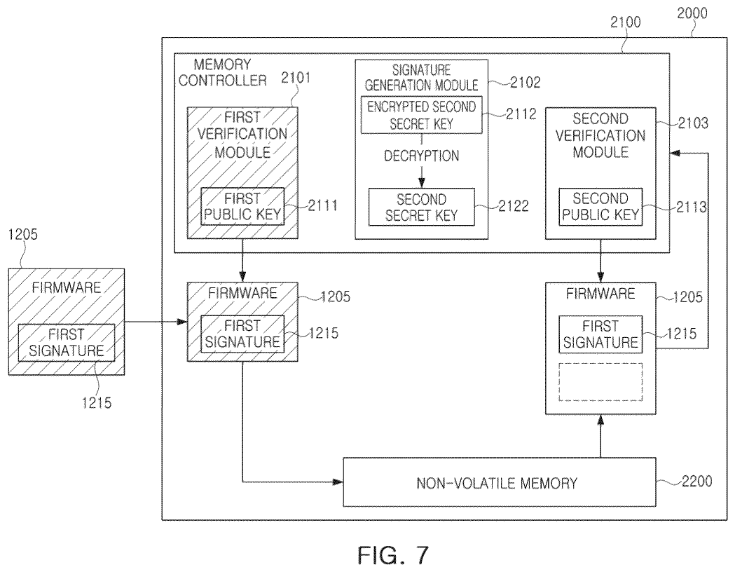

Hereinafter, in an example embodiment of the present disclosure, an operation of the storage device 2000 in a process of updating the firmware 1204, bypassing the storage device 2000 and stored, or the firmware 1204 forcibly downloaded to the non-volatile memory will be described with reference to FIGS. 7 to 9.

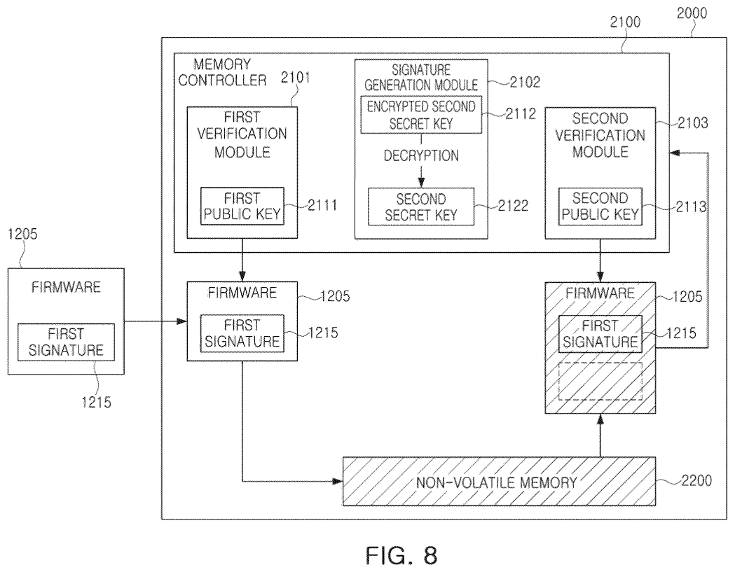

FIGS. 7 and 8 are diagrams illustrating an operation of a storage device according to an example embodiment of the present disclosure.

Referring to FIG. 7, a storage device 2000 according to an example embodiment of the present disclosure may include a memory controller 2100 and a non-volatile memory 2200. The memory controller 2100 may include a first verification module 2101, a signature generation module 2102, and a second verification module 2103.

In an example embodiment of the present disclosure, the storage device 2000 may externally download the firmware 1205. The firmware 1205 may include a first signature 1215 based on a first secret key. A first public key 2111 may be generated together with the first secret key used to encrypt a first signature, and may be pre-injected into the storage device 2000. The first verification module 2101 of the memory controller 2100 may verify the first signature 1215 of the firmware 1205 using the first public key 2111. When the first verification module 2101 successfully verifies the first signature 1215, the memory controller 2100 may complete downloading of the firmware 1205. The first signature 1215 of the firmware 1205 may be verified through the first verification module 2101, thereby identifying whether the firmware 1205 is firmware authenticated by a manufacturer of the storage device.

The firmware 1205 in which the first verification module 2101 successfully verifies the first signature 1215 may bypass the storage device 2000 and be stored in the non-volatile memory 2200. The firmware 1205, bypassing and stored in the non-volatile memory 2200, may not pass through the signature generation module 2102, such that the firmware 1205 may not include a second signature encrypted based on the second secret key 2122.

Referring to FIG. 8, the second verification module 2103 of the memory controller 2100 may load the firmware 1205 from the non-volatile memory 2200. The second verification module 2103 may verify the second signature, based on a second public key 2113. The firmware 1205, bypassing the storage device 2000 and stored, may not include the second signature, such that the second verification module 2103 may fail to verify the second signature of the firmware 1205. In an example embodiment, when the second verification module 2103 fails to verify the second signature, the memory controller 2100 may cancel loading of the firmware 1205.

The storage device 2000 according to an example embodiment of the present disclosure may include the signature generation module 2102 and the second verification module 2103 to identify whether the firmware 1205, stored in the non-volatile memory 2200, is the firmware 1205 authenticated by the storage device 200. Accordingly, even when it is identified that the firmware 1205 is authenticated by the manufacturer of the storage device 2000 through the first verification module 2101, the memory controller 2100 may not execute the firmware 1205 when the second verification module 2103 fails to verify the second signature.

The storage device 2000 according to an example embodiment of the present disclosure may write the second signature in the firmware 1205, and may verify the second signature using the second secret key 2122 and the second public key 2113 generated in the memory controller 2100, thereby identifying whether the firmware 1205 is authenticated by the storage device 2000 and executing the firmware 1205, and effectively enhancing security performance of the storage device 2000 in a firmware updating process.

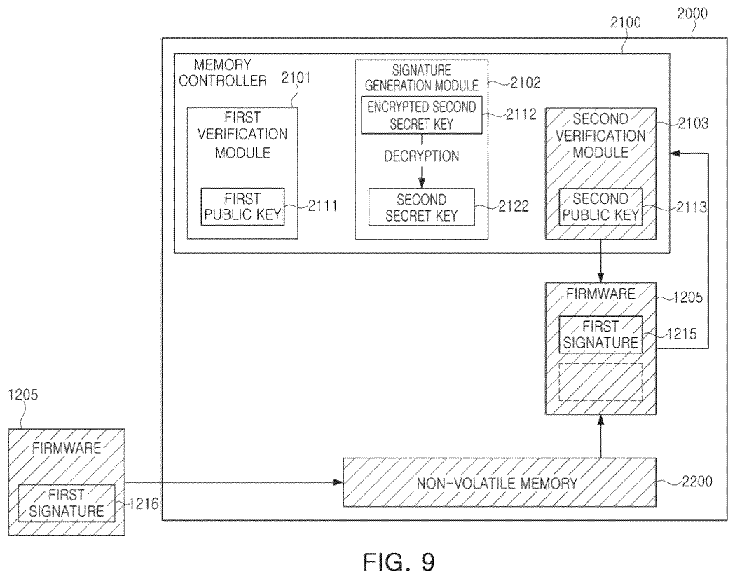

FIG. 9 is a diagram illustrating an operation of a storage device according to an example embodiment of the present disclosure.

Referring to FIG. 9, a storage device 2000 according to an example embodiment of the present disclosure may include a memory controller 2100 and a non-volatile memory 2200. The memory controller 2100 may include a first verification module 2101, a signature generation module 2102, and a second verification module 2103.

A firmware 1206 including a first signature 1216 may be replaced by the non-volatile memory 2200 while being stored in the non-volatile memory 2200 or may be forcibly downloaded to the non-volatile memory 2200. The firmware 1206 may be directly stored in the non-volatile memory 2200 without being transferred by a host to the storage device 2000, such that the first verification module 2101 may not verify the first signature 1216 of a firmware 1206 using the first public key 2111. Accordingly, the storage device 2000 may not identify whether the firmware 1206, stored in the non-volatile memory 2200, is the firmware 1206 authenticated by a manufacturer of the storage device 2000.

In an example embodiment of the present disclosure, the second verification module 2103 of the memory controller 2100 may load the firmware 1206 from the non-volatile memory 2200. The second verification module 2103 may verify a second signature of the firmware 1206, based on a second public key 2113. In an example embodiment, the memory controller 2100 may cancel loading of the firmware 1206 when the second verification module 2103 fails to verify the second signature. Referring to FIG. 9, the second signature of the firmware 1206 stored in the non-volatile memory 2200 may not be written by the signature generation module 2102, such that the second verification module 2103 may fail to verify the firmware 1206. Accordingly, the memory controller 2100 may cancel loading of the firmware 1206.

In an example embodiment of the present disclosure, the storage device 2000 may include the signature generation module 2102 and the second verification module 2103 to identifying whether the firmware 1206 stored in the non-volatile memory 2200 is authenticated by the storage device 200. Even when the externally injected firmware 1206 is stored in the non-volatile memory 2200 without being verified by the first verification module 2101, the second verification module 2103 may fail to verify the second signature.

The memory controller 2100 according to an example embodiment of the present disclosure may write the second signature in the downloaded firmware 1206 using a second secret key 2122 and the second public key 2113 generated in the memory controller 2100, and may verify the second signature, thereby verifying whether the firmware 1206 is updated according to an intention of a user, and executing the firmware 1206. Accordingly, the storage device 2000 may have effectively enhanced security performance in a firmware updating process.

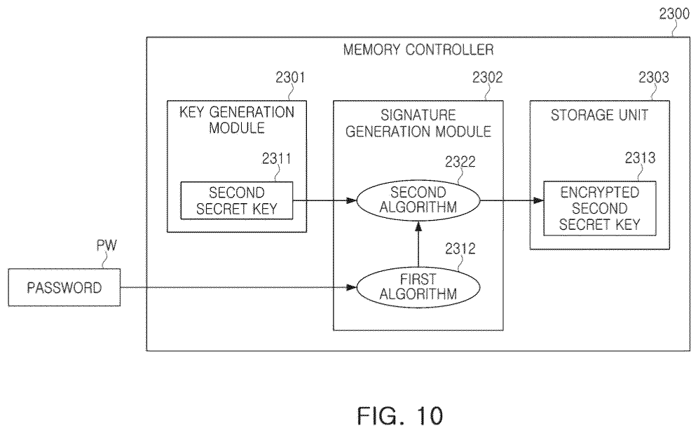

The storage device 2000 according to an example embodiment of the present disclosure may include a memory controller including a key generation module and the signature generation module 2102. The key generation module may generate the second secret key 2122 and the second public key 2113 when the storage device 2000 is initially booted. The memory controller 2100 may encrypt the second secret key 2122, based on an externally input password, and may store the encrypted second secret key 212 in the storage device 2000. The second secret key 2122 may be encrypted and stored based on the password, such that the password may also be required when the signature generation module 2102 intends to write the second signature, based on the second secret key 2122. The storage device 2000 may have effectively enhanced security performance by encrypting the second secret key 2122, based on the password, or writing the second signature. Hereinafter, the operation of the storage device 2000 will be described in detail with reference to FIGS. 10 to 12.

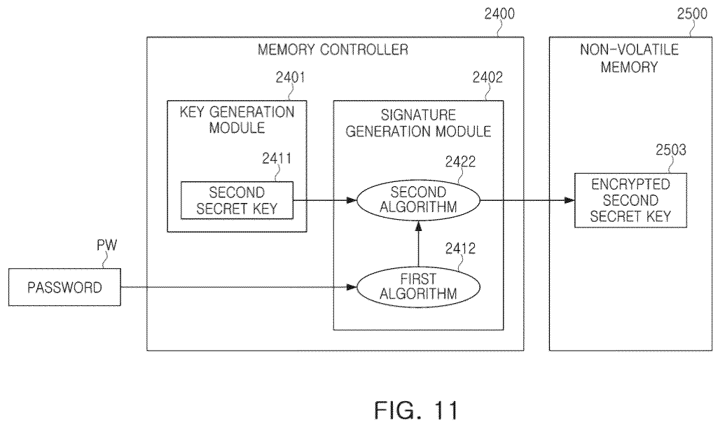

FIGS. 10 and 11 are diagrams illustrating an operation of a storage device according to an example embodiment of the present disclosure.

Referring to FIG. 10, a memory controller 2300, included in a storage device according to an example embodiment of the present disclosure, may include a key generation module 2301, a signature generation module 2302, and a storage unit 2303.

The key generation module 2301 according to an example embodiment of the present disclosure may generate a second secret key 2311 and a second public key when the storage device is initially booted. In an example embodiment, the second public key may be stored in the storage unit 2303 of memory controller 2300. The signature generation module 2302 may encrypt the second secret key 2311 and store the encrypted second secret key 2311 in the storage unit 2303. In an example embodiment, the second secret key and the second public key may be different from each other for each storage device. For example, even when a signature is written using a second secret key of a first storage device, verification may fail when a second public key of a second storage device, different from the first storage device, is used.

The signature generation module 2302 according to an example embodiment of the present disclosure may include at least one encryption algorithm. In an example embodiment, the signature generation module 2302 may include a first algorithm 2312 and a second algorithm 2322. For example, the first algorithm 2312 may be a key derivation function, and the second algorithm 2322 may be Advanced Encryption Standard (AES)-Galois/Counter Mode (GCM). When the second secret key 2311 is generated by the key generation module 2301, the signature generation module 2302 may encrypt the second secret key 2311 using a password PW.

Referring to FIG. 10, the memory controller 2300 according to an example embodiment of the present disclosure may receive the password PW from a user when the storage device is initially booted. The first algorithm 2312 of the signature generation module 2302 may generate a key protection key for encrypting the second secret key 2311 using the input password. In an example embodiment, when the password PW is changed, the key protection key may also be changed. The second algorithm 2322 may encrypt the second secret key 2311 using the key protection key. In an example embodiment, the encrypted second secret key 2313 may be stored in the storage unit 2303 of the memory controller 2300.

In the memory controller 2300 according to an example embodiment of the present disclosure, when the second secret key 2311 is generated by the key generation module 2301, the signature generation module 2302 may encrypt and store the second secret key 2311, based on the input password PW, such that the password PW may be required to decrypt the second secret key 2311. When the password PW is not input to the storage device, the signature generation module 2302 may not acquire the second secret key 2311 from the encrypted second secret key 2313, thereby effectively enhancing security performance of the storage device in a firmware updating process.

Referring to FIG. 11, the storage device according to an example embodiment of the present disclosure may include a memory controller 2400 and a non-volatile memory 2500. The memory controller 2400 may include a key generation module 2401 and a signature generation module 2402.

The key generation module 2401 of the memory controller 2400 according to an example embodiment of the present disclosure may generate a second secret key 2411 and a second public key when the storage device is initially booted. The second secret key 2411, generated by the key generation module 2401, may be encrypted using an externally input password PW and at least one encryption algorithm. In an example embodiment, the signature generation module 2402 may include a first algorithm 2412 and a second algorithm 2422. The first algorithm 2412 may generate a key protection key using the input password PW. The second algorithm 2422 may encrypt the second secret key 2411, based on the key protection key. In an example embodiment, the encrypted second secret key 2503 may be stored in the non-volatile memory 2500.

In an example embodiment of the present disclosure, the password PW may be changed and the encrypted second secret key 2503 may also be changed. When the password PW is changed, the key protection key generated by the first algorithm 2412 may also be changed based on the changed password PW. The second algorithm 2422 may generate an encrypted second secret key 2503, different from the existing encrypted second secret key, based on the second secret key 2411 and the changed key protection key.

For example, the first algorithm 2412 may generate a first key protection key, based on a first password. The second algorithm 2422 may generate a second secret key 2503 encrypted based on the first key protection key. When the first password is changed to a second password, the first algorithm 2412 may generate a second key protection key, based on the second password, and the second algorithm 2422 may regenerate a second secret key 2503 encrypted based on the second key protection key.

In an example embodiment, the first password and the second password may be different from each other, the first key protection key and the second key protection key are different, and the second secret key encrypted based on the first key protection key and the second secret key encrypted based on the second key protection key may be different from each other. However, even when the password PW and the encrypted second secret key 2503 are changed, the second secret key 2503 and the second public key may not be changed, and may be the same as the second secret key 2411 and the second public key generated by the key generation module 2401 when the storage device is initially booted.

In an example embodiment, the second secret key encrypted based on the first key protection key generated by the first algorithm 2412 may be stored in the non-volatile memory 2500. When the first password is changed to the second password, the second secret key encrypted based on the second key protection key may be stored in the non-volatile memory 2500 together with the second secret key encrypted based on the first key protection key. The encrypted second secret key 2503 may also be changed whenever the password is changed, such that a memory, storing the encrypted second secret key 2503, may require high storage capacity.

In the memory controller 2400 according to an example embodiment of the present disclosure, when the second secret key 2411 is generated by the key generation module 2401, the signature generation module 2402 may encrypt and store the second secret key 2411, based on the input password PW, such that the password PW may be required to decrypt the second secret key 2411. When the password PW is not input to the storage device, the signature generation module 2402 may not acquire the second secret key 2411 from the encrypted second secret key 2413, such the storage device may have enhanced security performance in a firmware updating process. In addition, the user may re-encrypt the second secret key 2411 of the storage device by changing the password PW, such that the storage device may have effectively enhanced security performance.

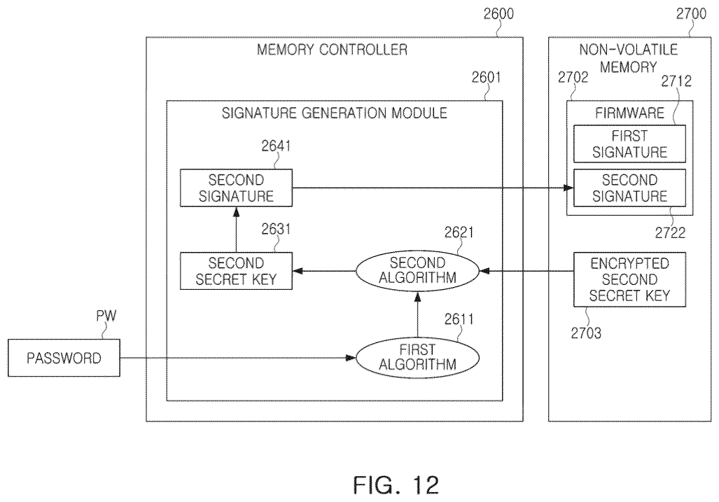

The memory controller 2400 according to an example embodiment of the present disclosure may encrypt the second secret key 2411, based on the password PW, and may store the encrypted second secret key 2503 in the storage device. A process of decrypting the encrypted second secret key 2503 based on an externally input password, and a process of writing a second signature in a firmware and authenticating the second signature will be described with reference to FIG. 12.

FIG. 12 is a diagram illustrating an operation of a storage device according to an example embodiment of the present disclosure.

Referring to FIG. 12, a storage device according to an example embodiment of the present disclosure may include a memory controller 2600 and a non-volatile memory 2700. The memory controller 2600 may include a signature generation module 2601, and the signature generation module 2601 may include at least one encryption algorithm.

Referring to FIG. 12, the signature generation module 2601 according to an example embodiment of the present disclosure may write a second signature 2722 in a firmware 2702, based on an externally input password PW. When a first verification module successfully verifies a first signature 2712, the signature generation module 2601 may write the second signature 2722 in the firmware 2702, based on a second secret key 2631. The second secret key 2631 may be stored in the non-volatile memory 2700 in a state of being encrypted based on the password PW, such that the password PW may be required for the signature generation module 2601 to decrypt the encrypted second secret key 2703. In an example embodiment, the encrypted second secret key 2703 may be stored in a storage unit of the memory controller 2600.

In an example embodiment of the present disclosure, the signature generation module 2601 may decrypt the encrypted second secret key 2703 using the input password PW and at least one encryption algorithm. In an example embodiment, the signature generation module 2601 may include a first algorithm 2611 and a second algorithm 2621. The first algorithm 2611 may generate a key protection key using the input password PW. The second algorithm 2621 may acquire the second secret key 2631 by decrypting the second secret key 2703 encrypted based on the key protection key. The signature generation module 2601 may write the second signature 2722 in the firmware 2702, based on the second secret key 2631, and the firmware 2702 in which the second signature 2722 is written may be stored in the non-volatile memory 2700.

In an example embodiment of the present disclosure, the signature generation module 2601 may write the second signature 2721 in the firmware 2702, based on the second secret key 2631, thereby identifying whether the firmware 2702 is firmware authenticated by the storage device. Before the firmware 2702 is executed, a second verification module of the memory controller 2600 may verify the second signature. When the second verification module successfully verifies the second signature 2721, it may be identified that the firmware 2702 is firmware authenticated by the storage device. When the signature generation module 2601 intends to write the second signature 2721 in the firmware 2702, based on the second secret key 2631, the password PW may be required, and the firmware 2702 may be authenticated and verified based on the second secret key 2631, thereby reducing issues such as leakage of personal information or important data included in the storage device, and providing a storage device having effectively enhanced security performance.

According to example embodiments of the present disclosure, a memory controller may generate a secret key and a public key during initial booting, write a signature in externally downloaded firmware and authenticate the firmware, based on the secret key, and execute the firmware after verifying the written signature. A signature generation module of the memory controller may encrypt and decrypt a secret key for writing a signature in the firmware using an externally input password, thereby identifying whether the firmware is firmware authenticated by the storage device in a firmware updating process, and enhancing the security of the storage device.

While example embodiments have been shown and described above, it will be apparent to those skilled in the art that modifications and variations could be made without departing from the scope of the present inventive concept as defined by the appended claims.

What is claimed is:

1. A storage device comprising:
a non-volatile memory; and
a memory controller configured to:
download firmware into the non-volatile memory, the firmware comprising a first signature that is generated based on a first secret key;
verify the first signature of the firmware using a first public key that is paired with the first secret key;
decrypt a second secret key using an externally received password;
write a second signature in the firmware, based on the second secret key;
verify the second signature of the firmware using a second public key that is paired with the second secret key; and
store the first public key and the second public key.

2. The storage device of claim 1, wherein the non-volatile memory stores the firmware including the second signature, and
wherein the memory controller is further configured to load the firmware from the non-volatile memory.

3. The storage device of claim 1, wherein the memory controller is further configured to execute the firmware based on a success to verify the second signature of the firmware.

4. The storage device of claim 1, wherein the memory controller is further configured to cancel loading of the firmware based on a failure to verify the second signature of the firmware.

5. The storage device of claim 1, wherein the memory controller is further configured to generate the second secret key and the second public key during initial booting of the storage device.

6. The storage device of claim 1, wherein the memory controller is further configured to encrypt the second secret key using at least one encryption algorithm, based on the password.

7. The storage device of claim 6, wherein the memory controller is further configured to decrypt the second secret key that is encrypted using the at least one encryption algorithm, based on the password.

8. The storage device of claim 1, wherein the memory controller is further configured to store the second secret key in an encrypted form in a storage of the memory controller, and load the second secret key from the storage of the memory controller.

9. The storage device of claim 1, wherein the memory controller is further configured to store the second secret key in an encrypted form in the non-volatile memory, and load the second secret key from the non-volatile memory.

10. The storage device of claim 1, wherein the first public key is pre-stored in the memory controller.

11. The storage device of claim 1, wherein the memory controller is further configured to check integrity of the firmware.

12. The storage device of claim 1, wherein the password comprises at least one of numbers and English characters.

13. The storage device of claim 1, wherein the first signature is encrypted based on the first secret key, and the encrypted first signature is decrypted only with the first public key.

14. The storage device of claim 1, wherein the second signature is encrypted based on the second secret key, and the encrypted second signature is decrypted only with the second public key.

15. A storage device comprising:
a non-volatile memory; and
a memory controller configured to:
generate a second secret key and a second public key during initial booting of the storage device;
encrypt the second secret key using at least one encryption algorithm, based on an externally received password;
decrypt the second secret key encrypted using the at least one encryption algorithm;
write a second signature to firmware externally downloaded into the non-volatile memory, based on the second secret key;
perform a verification process on the second signature of the firmware using the second public key; and
execute the firmware based on a success of the verification process on the second signature.

16. The storage device of claim 15, wherein the at least one encryption algorithm comprises a key derivation function.

17. The storage device of claim 15, wherein the at least one encryption algorithm comprises Advanced Encryption Standard (AES)-Galois/Counter Mode (GCM).

18. A storage device comprising:
a non-volatile memory; and
a memory controller configured to:
generate a second secret key and a second public key during initial booting of the storage device;
generate a key protection key based on a first encryption algorithm and a password received from an external source;
encrypt the second secret key based on the key protection key and a second encryption algorithm;
store the encrypted second secret key in the non-volatile memory;
decrypt the encrypted second secret key based on the password, the first encryption algorithm, and the second encryption algorithm,
write a second signature to firmware externally downloaded into the non-volatile memory, based on the second secret key; and
verify the second signature of the firmware using the second public key,
wherein the first encryption algorithm is configured to regenerate the key protection key based on a change in the password, and the second encryption algorithm is configured to regenerate the second secret key to be different from a previous version of the second secret key, based on the regenerated key protection key.

19. The storage device of claim 18, wherein the first encryption algorithm is configured to generate a first key protection key based on a first password, and the second encryption algorithm is configured to generate the second secret key encrypted based on the first key protection key and store the encrypted second secret key in the non-volatile memory,
wherein, based on the first password being changed to a second password, the first encryption algorithm is configured to generate a second key protection key based on the second password, and the second encryption algorithm is configured to generate the second secret key encrypted based on the second key protection key, and
wherein the memory controller is further configured to store the second secret key encrypted based on the second key protection key, in the non-volatile memory, together with the second secret key encrypted based on the first key protection key.

20. The storage device of claim 18, wherein the second secret key and the second public key remain the same as those generated during the initial booting, even when the password is changed.
